(19) United States
(12) Patent Application Publication
(10) Pub. No.: US 2006/0143410 A1
(43) Pub. Date: Jun. 29, 2006

(54) Method And Related Apparatus For Realizing Two-Port Synchronous Memory Device

(76) Inventors: Sheng-Chung Chen, Taipei Hsien (TW); Jung-Tsan Hsu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/906,887

(22) Filed: Mar. 10, 2005

(30) Foreign Application Priority Data
Dec. 29, 2004 (TW) 093141208

(51) Int. Cl. G06F 13/28

(52) U.S. Cl. 711/149

(57) ABSTRACT

Method and related apparatus for realizing a two-port synchronous memory device with a single-port memory. Clock-triggered two-port synchronous memory device can synchronously receive reading and writing commands within a clock period to simultaneous execute these two commands, while a single port memory must execute a single reading and writing command sequentially. Since a single-port memory features a lower cost and a smaller layout area, the invention realizes a two-port synchronous memory device by making a single-port memory first execute one of the reading/writing commands and then the other command within a single clock period, such that the two commands are completed after a single clock period. Thus a two-port synchronous memory device can be realized with a single-port memory.

### BACKGROUND OF INVENTION

1. Field of the Invention

The invention relates to a method and related apparatus for realizing a multi-port synchronous memory device, and more particularly, to a method and related apparatus for utilizing a single-port memory of low cost and small layout area to realize a multi-port synchronous memory device.

2. Description of the Prior Art

In today's society, data, information, documents, and videos can be processed, transferred, managed, and stored in an electronic form (especially a digital electronic form). Therefore, electronic circuits for transferring electronic signals and managing electronic data become key points of design. This is especially true of widely utilized multi-port synchronous memory devices that can read/write data synchronously. The multi-port synchronous memory devices can be triggered by a clock such that the memory devices can synchronously receive and complete the execution of a reading command and a writing command in the same clock period. In other words, when data are being written in a specific address of the memory devices, another data can be read from another address of the memory device.

Multi-port synchronous memory devices can be utilized as registers because of their synchronous reading and writing characteristic (e.g., a first-in-first-out register), for performing queue management, or as a buffer in a data transmission route. For example, a control circuit having a complex function utilizes a queue operation for different tasks (i.e., tasks are processed in a queue). The above-mentioned first-in-first-out (FIFO) register can be utilized for storing the tasks of a queue. Additionally, tasks can be orderly stored temporarily in the FIFO register based on different priorities. Tasks that are stored in the register earlier can be read and processed earlier. In other words, the function of the FIFO register is similar to a FIFO stack. The FIFO register can read temporarily stored data that was earlier input to the register and store other data that are input to the register later. As described above, the two-port synchronous memory devices can operate as FIFO registers.

In the data transmission route, when a certain device A has to orderly transfer data to another device B, but the device B cannot receive the data from A at device A's transmission rate, a buffer can be established between the device A and device B. The device A can transfer data to the buffer (i.e., write data into the buffer) according to its original transmission rate, the device B can receive data from the buffer (i.e., read data from the buffer) according to device B's receiving rate. In this case, because the device A and device B have to access the buffer at the same time, the above-mentioned two-port synchronous memory device can achieve the buffer.

As mentioned above, the two-port synchronous memory device can be widely utilized in many kinds of electronic circuits. However, in the prior art, the two-port synchronous memory device is achieved by a two-port static random access memory with a high cost and a large layout area. In a two-port memory, each memory cell for storing 1-bit data has two access ports, wherein each access port has a specific access-controlling transistor. Furthermore, the two-port memory must comprise two independent data transmission lines, wherein each data transmission line is connected to each memory cell through an access port of each memory cell. For example, certain memory cells C1 and C2 both comprise a first accessing port and a second accessing port. The first accessing port of the memory cells C1 and C2 are connected to a first data transmission line, and the second accessing port of the memory cells C1 and C2 are connected to a second data transmission line. For example, when the two-port synchronous memory device is synchronous stored and read, certain data can be read from the memory cell C1 and another data can be written into the memory cell C2. Next, the first accessing port of the memory cell C1 can be turned on (conductive) so that the data of the memory cell C1 can be transferred through the first data transmission line. Simultaneously, the first accessing port of the memory cell C2 can be turned off (unable to conduct) so that the memory cell C2 does not transfer any data of the memory cell C2 incorrectly through the first data transmission line. When the memory cell C1 transfers data through the first accessing port to the first data transmission line, the second accessing port of the memory cell C2 can be turned on (conductive) so that the data can be transferred through the second data transmission line to the memory cell C2 and be written into the memory cell C2. Simultaneously, the second accessing port of the memory cell C1 can be turned off (unable to conduct) to prevent the memory cell C1 from incorrectly receiving data that should be transferred to the memory cell C2 from the second data transmission line.

The above-mentioned prior art two-port memory can achieve the function of the two-port synchronous memory device, however, each memory cell of the two-port memory must comprise two accessing ports and the corresponding access controlling transistor. This causes the two-port memory to occupy a larger layout area, require more complex circuit structure, and cost more to produce and design. Therefore, the two-port synchronous memory device achieved by the above-mentioned two-port memory is not widely utilized due to its disadvantages.

### SUMMARY OF INVENTION

It is therefore one of primary objectives of the claimed invention to provide a method and related apparatus capable of utilizing a single-port memory to achieve functions of the two-port synchronous memory device to solve the above-mentioned problem.

According to an exemplary embodiment of the claimed invention, a method for realizing a two-port synchronous memory device with a memory is disclosed. The method comprises: receiving a reading command; the reading command is utilized to read data from the memory; when receiving the reading command, synchronously receiving a writing command; the writing command is utilized to write data into the memory; and when receiving the reading command and the writing command, performing a selecting step to select one of the two commands and to execute the selected command, and executing the other command after completely executing the selected command.

In addition, a memory device is disclosed. The memory device comprises: a memory for storing data; and a control interface capable of synchronously receiving a writing command and a reading command; wherein the writing command is utilized to write data into the memory and the reading command is utilized to read data from the memory; and the control interface comprises: a selecting module capable of selecting a command from the two commands and causing the memory to execute the selected command when the control interface receives the reading command and the writing command; and causing the memory to continuously execute the other command after the selected command is executed completely.

The single-port memory processes one single reading or writing command at a time, however, the single-port memory (especially an SRAM) can process the reading/writing command very quickly. Therefore, the claimed invention utilizes the single-port memory to process one of either the reading or the writing commands in the first half of the clock period and then to process the other command in the last half of the clock period. In other words, the single-port memory process two commands in the same clock period effectively functioning as a two-port synchronous memory device.

In the actual implementation, the claimed invention couples the single-port memory with a control interface to achieve the multi-port memory device. In an embodiment of the claimed invention, the control interface can comprise an arbitrator. When the control interface simultaneously receives a reading command and a writing command, the arbitrator can transfer one of the two commands to the single-port memory according to their predetermined priorities. The single-port memory can first process the command selected by the arbitrator and then process the other command. For example, the arbitrator can be set to assign the reading command a higher priority. Therefore, when the control interface receives two commands in the same clock period, the arbitrator can transfer the reading command to the single-port memory. The single-port memory completes the read data in the first half of the clock period and then the writing command is transferred to and completed by the single-port memory in the last half of the clock period In other words, the single-port memory process two commands in the same clock period effectively functioning as a multi-port synchronous memory device.

In another embodiment of the claimed invention, the control interface can comprise a double frequency clock circuit. When the control interface is triggered by an external clock to synchronously receive a reading command and a writing command, in a clock period of the external clock, the clock circuit can generate a clock with a double frequency. In this embodiment, the clock with a double frequency is utilized to control the single-port memory. This causes the single-port memory to process the reading command and the writing command in different clock periods of the inner clock generated by the inner clock circuit. However, the inner clock has double the frequency of the external clock the period of the inner clock is half that of the period of the external clock. Therefore, if the inner clock controls the single-port memory, the single-port memory processes the reading command and the writing command in the same clock period of the external clock. In other words, the single-port memory functions as a multi-port memory device.

In a single-port memory, each memory cell of the single-port memory comprise only one accessing port. Therefore, the single-port memory can have a small layout area and low cost. Typically, each memory cell of the single-port SRAM comprises 6 transistors (6T) or comprises 4 transistors and 2 resistors (2R4T). The two-port SRAM comprises 8 transistors (8T) or comprises 6 transistors and 2 resistors (2R6T). Comparing the two memories, it can be seen that the single-port memory has a smaller layout area and lower cost. Therefore, the present invention can achieve the functions of the more costly and larger two-port synchronous memory device by utilizing less expensive and smaller single-port memory.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a typical two-port synchronous memory device.

FIG. 2 is a timing diagram of related signals in the operation of the two-port synchronous memory device shown in FIG. 1.

FIG. 3 is a block diagram of a memory device of an embodiment according to the present invention.

FIG. 4 is a timing diagram of related signals in the operation of the memory device shown in FIG. 3.

FIG. 5 is a block diagram of a memory device of another embodiment according to the present invention.

FIG. 6 is a timing diagram of related signals in the operation of the memory device shown in FIG. 5.

FIG. 7 is a circuit diagram of memory cells of a single-port memory and a two-port memory device.

### DETAILED DESCRIPTION

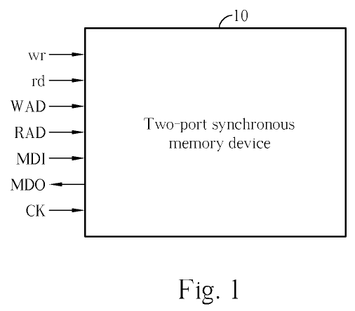

Please refer to FIG. 1, which is a diagram of a typical two-port synchronous memory device 10. The two-port synchronous memory device 10 can be a SRAM, which receives a clock CK, signals wr, rd, WAD, RAD, and MDI, and outputs a signal MDO. The clock CK is utilized to trigger the operational timing of the two-port synchronous memory device 10. The signals wr and rd are respectively a writing enabling signal and a reading enabling signal. When the two signals change from a low level to a high level, the two-port synchronous memory device 10 performs a data writing command or a data reading command according to the changed signals. In other words, when the signal wr or rd is enabled to a high level a writing command or a reading command is sent to the two-port synchronous memory device 10. When the signal wr is enabled to a high level the two-port synchronous memory device 10 is asked to write data in itself. Next, the signal WAD synchronously transfers address information to notify the certain address that the two-port synchronous memory device 10 needs to write data. Finally, the data to be written is carried by the signal MDI to the two-port synchronous memory device 10 for the writing operation. Conversely, when the signal rd is enabled to a high level, the two-port synchronous memory device 10 is asked to read data from itself. Next, the signal RAD synchronously transfers address information to the two-port synchronous memory device 10. Finally, the two-port synchronous memory device 10 can read data from a certain address according to the address information and then outputs the read data to the signal MDO.

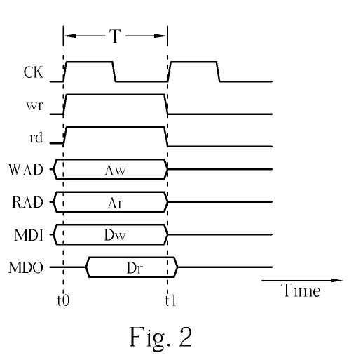

As mentioned above, a function of the two-port synchronous memory device 10 is to synchronously complete the reading operation and the writing operation in the same clock period. Please refer to FIG. 2 (in conjunction with FIG. 1). FIG. 2 is a timing diagram of related signals in the operation of the two-port synchronous memory device 10 shown in FIG. 1. The horizontal axis shown in FIG. 2 represents time. As shown in FIG. 2, in the same clock period T, the signals wr and rd are enabled to a high level at the same timing t0(i.e., the two-port synchronous memory device 10 is asked to process the data reading and data writing at the same time). When the signals wr and rd are enabled to a high level, the signals WAD and RAD synchronously transfer addresses Aw and Ar to indicate the addresses of data reading and data writing. In the signal MDI, the data Dw to be written into the address Aw are transferred to the two-port synchronous memory device 10. After the clock period T of the clock CK finishes at timing t1, the two-port synchronous memory device 10 has written the data Dw in the address Aw, read data Dr from the address Ar, and outputted the data Dr to the signal MDO. Therefore, the data Dr can be obtained at timing t1 from the signal MDO.

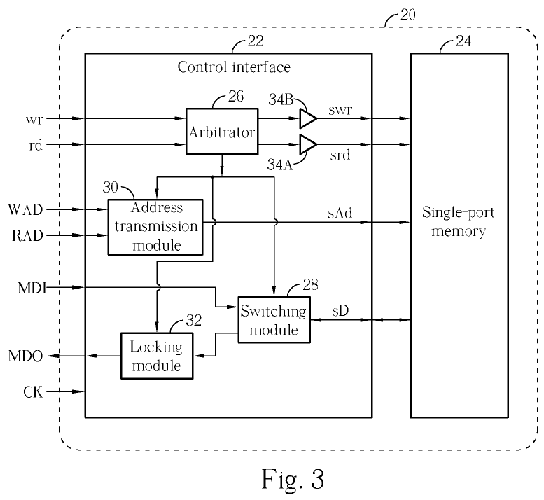

One purpose of the present invention is to utilize the single-port memory to achieve the access timings of the two-port synchronous memory device shown in FIG. 2. In other words, the present invention utilizes the single-port memory to synchronously receive reading/writing commands and to process the data reading and data writing in the same clock period. Please refer to FIG. 3, which is a block diagram of a memory device 20 of an embodiment according to the present invention. The memory device 20 comprises a control interface 22 and a single-port memory 24 (it can be a single-port SRAM) to achieve the function of the two-port synchronous memory device. As discussed above, the single-port memory must perform one operation before starting the next (such as the data writing operation or the data reading operation). Therefore, the single-port memory 24 can receive only one address signal sAD, or transfer only one input/output signal sD. When the signal swr is enabled, the single-port memory 24 writes data carried by the signal sD to the address carried by the signal sAD. When the signal srd is enabled, the single-port memory 24 reads data from the address of the signal sAD and outputs the data to the signal sD. By utilizing the same port and the same signal to transfer the reading/writing address and data, the single-port memory 24 benefits from a simple circuit structure, low cost, and small layout area. Please note that the reading/writing enabling signals swr, srd cannot be enabled simultaneously.

To utilize the single-port memory 24 to achieve the function of the two-port memory device, the present invention control interface 22 is utilized to transform the above-mentioned standard signals rd, wr, WAD, RAD, MDI, and MDO of the two-port memory device into control signals swr, srd, sAD, and Sd of the single-port memory. In this embodiment of FIG. 3, the control interface 22 comprises an arbitrator 26, two delay units 34A and 34B, an address transmission module 30, a switching module 30, and a locking module 32. The arbitrator 26 controls the address transmission module 30, the switching module 30, and the locking module (latch) 32. In this embodiment, the arbitrator 26 can be regarded as a selecting module. When the arbitrator 26 receives signals wr and rd, both enabled, the arbitrator 26 can select one of the signals wr and rd according to predetermined priorities and then transfer the selected signal to the single-port memory 24. For example, the arbitrator 26 can assign signal rd a higher priority. Therefore, when the signals rd and wr are enabled to a high level, the arbitrator 26 can first pass the reading command (the signal rd) to the single-port memory 24 then pass the writing command (the signal wr). In coordination with the arbitrator 26, the address transmission module 30 can orderly arrange the addresses information of the signals RAD and WAD into the signal sAD. If the reading command has higher priority then the address transmission module 30 first arranges the reading address of the signal SAD into the signal sAd. Until the arbitrator 26 transfers the writing command to the single-port memory 24, the address transmission module 30 is switched to arrange the writing address of the signal WAD into the signal sAd. Similarly, the switching module 28 also switches the data inputting/outputting based on the result of the arbitrator 26. If the reading command is transferred to the single-port memory 24 and executed first, then the signal sD is transferred to the locking module to perform a latching operation. When the arbitrator 26 transfers the lower priority writing command into the single-port memory 24, the switching module 28 switches the route of data transmission. Therefore, when the writing command is executed, data to be written is transferred from the signal MDI to the signal sD. Please note that in this embodiment, the locking module 32 can comprise one or multiple locking units to latch/store data; furthermore, each delay unit 34A and 34B is predominately utilized to delay the signal of the arbitrator 26.

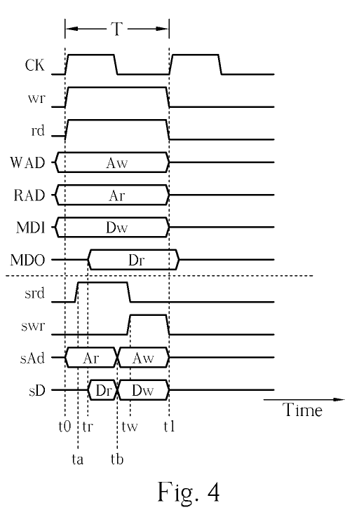

In other words, when the external signals wr and rd are enabled in the same clock period, the arbitrator 26 can select one signal to execute first. This allows the single-port memory 24 to orderly perform data reading and data writing. Typically, the single-port memory 24 requires less than one clock period to execute the data reading or data writing even when the data reading and the data writing are executed sequentially. This achieves the functional equivalent of the two-port synchronous memory device. For further illustrating the accessing operation of the memory device 20, please refer to FIG. 4 in conjunction with FIG. 3. FIG. 4 is a timing diagram of related signals in the operation of the memory device 20 shown in FIG. 3. The horizontal axis of FIG. 4 represents time.

As shown in FIG. 4, at timing t0, the external signals wr and rd are simultaneously enabled to a high level meaning that the memory device 20 is asked to perform the data reading and data writing synchronously. At the same time, the data to be written and the addresses Aw and Ar, respectively for data writing and data reading are transferred to the memory device 20 through the signals WAD and RAD. When the arbitrator 26 (shown in FIG. 3) senses the signals wr and rd are enabled simultaneously at timing t0, the arbitrator 26 can first pass the higher priority reading command (the signal rd), to the single-port memory 24. The level change of the signal rd is reflected by the level change of the signal srd. The signal srd changes to a high level at timing ta because the delay unit 34A delays the signal srd.

When the arbitrator 26 selects the reading command at timing t0, the selecting result simultaneously makes the address transmission module 30 transfer the address Ar of the signal RAD to the signal sAD. At the same time, the switching module 28 switches the locking module 32 to await the output data of the signal sD. The address transmission module 30 can stably transfer the address Ar, which is needed for data reading, through the signal sAD up until time ta. The signal srd causes the single-port memory 24 to begin the data reading at time ta. Through the time tr, the single-port memory 24 completes the data reading and then outputs the read data Dr of the address Ar to the signal sAd. Next, the data Dr carried on the signal sAD is transferred to the locking module 32 through the switching module 28. Now the locking module 32 latches the data Dr to be data carried by the output signal MDO.

After the arbitrator 26 transfers the reading command to the single-port memory 24 it transfers the writing command to the single-port memory 24 at time tb. At this time, the address transmission module 30 changes to transfer the address Aw of the signal WAD to the signal sAD, and the switching module 28 also switches into the signal MDI to transfer data Dw, which is to be written, of the signal MDI to the signal sD. Please note that the data Dr latched in the locking module 32 are not affected. At timing tw, the address transmission module 30 and the switching module 28 can stably transfer the address Aw and data Dw through the signals sAd and sD. Simultaneously, because of the delay unit 34B, the signal swr is changed to a high level at timing tw. This also means the single-port memory 24 is asked to execute a writing command. And the single-port memory 24 can write the data Dw into the address Aw. At timing t1, one period T of clock CK finishes, the memory device 20 also completes the data reading and data writing. Therefore, the memory device 20 achieves the function of two-port synchronous memory device.

In other words, when the present invention memory device 20 synchronously receives an external reading command or writing command, the arbitrator 26 is utilized to select one of the two commands. This makes the single-port memory 24 respectively execute data reading and data writing in the first half and last half of the clock period. Therefore, the single-port memory having lower cost and a smaller layout area can be utilized to achieve the function of the two-port synchronous memory device. If the memory device 20 only receives one command (such as the reading command or the writing command), the arbitrator 26 can directly transfer the command to the single-port memory 24 without a selecting operation allowing the single-port memory 24 to directly execute the data reading or data writing. In all cases such as data reading, data writing, or synchronous data reading and data writing, the memory device 20 can correctly execute in a single clock period of the clock, just as well as the two-port synchronous memory device. Furthermore, in the memory device 20, the clock CK can directly control switching functions of the address transmission module 30 and the switching module 58. In other words, the address transmission module 30 can transfer the address of the signal RAD in the first half clock period then transfer the address of the signal WAD in the second half clock period. Similarly, the switching module 58 can operate according to the clock CK. In order to determine the priorities of the reading/writing command in the same period of the clock CK, the arbitrator 26 can work in a clock, whose frequency is higher than the clock CK.

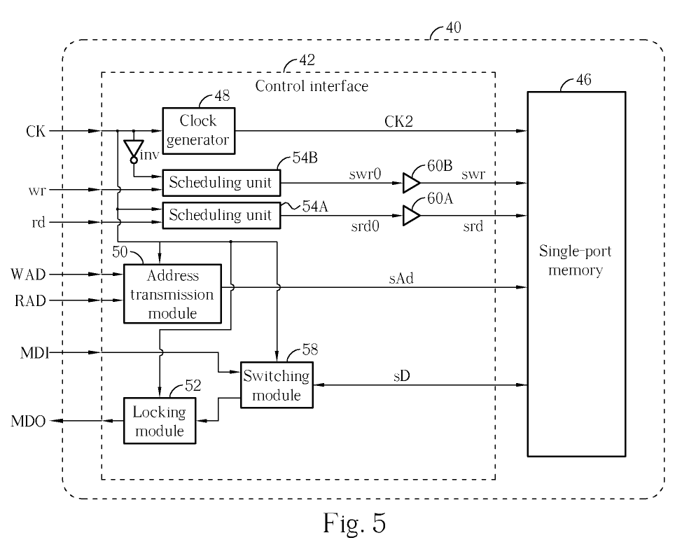

In a second embodiment of the present invention, a clock having double frequency triggers the single-port memory. Please refer to FIG. 5, showing a block diagram of a memory device 40 of another embodiment according to the present invention. The memory device 40 also comprises a control interface 42 and a single-port memory 46 to achieve the function of the two-port synchronous memory device. In this embodiment, the control interface 42 comprises a clock generator 48, delay units 60A and 60B, two scheduling units 54A and 54B, an address transmission module 50, a switching module 58, and a locking module 52. Please note that the clock generator 48 can be a phase lock loop for generating a clock CK2 whose frequency is double that of the clock CK (the clock period of the clock CK is half of the clock period of the clock CK). The clock CK2 is utilized to trigger the operational timings of the single-port memory 46. Under the triggers of the clock CK2, the single-port memory 46 can receive a reading command or a writing command from the signals srd or swr, receive the address for data reading or data writing from the signal sAD, and output data or receive data through the signal sD in a single whole clock period of the clock CK2.

In the control interface 42, the scheduling units 54A and 54B can determine whether the external signals wr and rd are transferred to the delay units 60A and 60B through the signals swr0 and swr0 to generate corresponding signals swr and srd. In the actual implementation, the scheduling units 54A and 54B can be achieved by AND gates. When the external signals wr and rd are enabled to a high level in the same period of the clock CK, the scheduling unit 54A can perform an AND operation on the clock CK and the signal rd. This causes the high level of the signal rd to be transferred to the delay unit 60A in the first half clock period (the high level of the clock). Additionally, the scheduling unit 54B can perform an AND operation on an inversed clock, which is inversed by an inverter inv shown in FIG. 5 This causes the high level of the signal wr to be transferred to the delay unit 60B in the last half clock period. In other words, the scheduling units 54A and 54B can be respectively enabled in the first/last half of the clock period of the clock CK. This allows the scheduling units 54A and 54B to serve as a selecting module. Therefore, the reading command and writing command of the signals wr and rd can be transferred to the signals swr0 and srd0. Please note the address transmission module 50, the switching module 58, and the locking module 52 in this embodiment are similar to the corresponding modules having the same names in the first embodiment, thus further illustration is omitted.

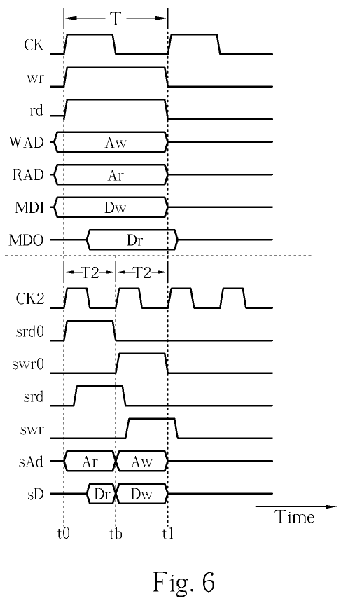

Please refer to FIG. 6 (in conjunction with FIG. 5). FIG. 6 is a timing diagram of related signals in the operation of the memory device 40 shown in FIG. 5. The horizontal axis represents time. As shown in FIG. 6, during period T of the clock CK, the external signals rd and wr are enabled to a high level at timing t0. This means that the memory device 40 is asked to perform data reading and data writing. The signal srd0 changes to a high level in the first half period of the clock CK causing a reading command to be sent to the single-port memory 46. Therefore, in the first half of the clock CK, the address transmission module 50 transfers the reading address Ar of the reading address Ar to the signal sAD and the switching module 58 can also switch to the locking module 52. The single-port memory 46 is operated according to the clock CK2. The single port memory 46 can complete data reading of data Dr from the address Ar according to the signal sAD in a period T2 of the clock CK2 (this is equal to a half period of clock CK). The data Dr can be transferred to the locking module 52 through the switching module 58 and latched by the locking module 52 then carried on the external signal MDO.

The scheduling unit 54A stops transferring the signal rd to the signal srd until timing tb, which is located in the last half period of the clock CK. Conversely, the scheduling unit 54B is enabled by a high level of the signal wr to reflect on the signal swr0 and generate delayed signal swr through the delay unit 60B. Simultaneously, the address transmission module 50 changes to transfer the address Aw of the signal WAD to the signal sAD. The switching module 58 also switches to the signal MDI to transfer data Dw of the signal MDI to the signal sD. Because the last half period of clock CK is another period of the clock CK2. Therefore, for the single-port memory 46, single-port memory 46 receives the writing command from the signal swr in a new clock period of the clock CK2 and the single-port memory 46 write the data Dw to the address Aw in this new period T2. At timing t1, a period T of the clock CK finishes. But the single-port memory 46 experiences two periods T2 of clock CK2. Therefore, the single-port memory 46 performs data reading and data writing in one clock period T2 of the clock CK2. In other words, the single-port memory 46 achieves the function of the two-port synchronous memory device.

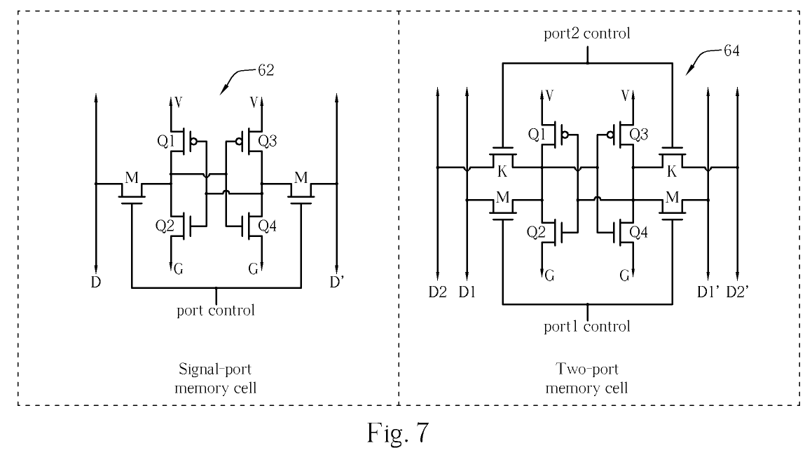

Please refer to FIG. 7, which is a circuit diagram of memory cells of a single-port memory and a two-port memory device. The memory cell 62 is a single-port memory cell capable of storing 1-bit data. As shown in FIG. 7, the transistors Q1-Q4 and two transistors M form the memory cell 62. The transistors Q1-Q4 form a main circuit for data storage. The two transistors M are access controlling transistors of the accessing port for determining if the memory cell 62 can transfer data in the data transmission line D and D′. The present invention utilizes the single-port memory cell to achieve the function of the two-port synchronous memory device. In contrast to the prior art that must utilize the two-port memory to achieve the two-port synchronous memory device. As shown in FIG. 7, the two-port memory cell 64 must comprise 8 transistors. In addition to transistors Q1-Q4, the memory cell must also comprise 4 transistors M and K to manage two accessing ports. In this embodiment the two transistors M are predominately utilized for determining if data can be transferred through the data transmission line D1 and D1′. The two transistors K are utilized for determining if data can be transferred through the data transmission line D2 and D2′. As shown in FIG. 7, because the present invention can utilize the single-port memory to achieve the function of the two-port synchronous memory device, the present invention can reduce the layout area and the cost of the two-port synchronous memory device.

In summary, when the present invention achieves the multi-port synchronous data accessing operation, the present invention orderly processes the reading command and the writing command received in the same clock period. Therefore, the present invention can complete data accessing orderly in the same period. In other words, the present invention successfully utilizes the single-port memory to achieve the functionality of the two-port memory device but with reduced, cost and layout area.

Please note that in the above-mentioned memory device 20 and 40, the reading command has higher priority than the writing command. This is utilized as an illustration, not a limitation. In fact, the writing command can have higher priority than the reading command. That is, the priority can be determined based on the design demands. Furthermore, the technique of the present invention can be expanded to a multi-port synchronous memory device. For example, the memory device 40 can generate clock CK2, whose frequency is M times the clock CK and the memory device 40 can utilize the appropriate address transmission module and the switching module to achieve the function of the M-port synchronous memory device. Please note that in the memory devices 20 and 40, a hardware circuit or a firmware can achieve each module. For example, the address transmission module and the switching module can be achieved by one or multiple multiplexers.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of performing synchronous two-way transmission in a memory device, the method comprising:
receiving a reading command, wherein the reading command is utilized to read data from the memory;
when receiving the reading command, synchronously receiving a writing command, wherein the writing command is utilized to write data into the memory; and
when receiving the reading command and the writing command, performing a selecting step to select one of the two commands and to execute the selected command, and executing the other command after completely executing the selected command.

2. The method of claim 1 further comprising:
when receiving the reading command, synchronously receiving a reading address; the reading command is utilized to read data from the reading address of the memory; and
when receiving the writing command, synchronously receiving a writing address; the writing command is utilized to write data into the writing address of the memory.

3. The method of claim 1 further comprising:
receiving a clock; the clock comprises a plurality of periods;
wherein the step of synchronously receiving the reading command and the writing command is receiving the reading command and the writing command in the same clock period.

4. The method of claim 3, wherein the step of selecting one of the two commands and executing the two commands is executing the two commands in the same clock period.

5. The method of claim 1 further comprising:
if the reading command is selected, performing a latching step to store the data read according to the reading command.

6. The method of claim 1, wherein the memory is a single-port memory.

7. A memory device comprising:
a memory for storing data; and
a control interface capable of receiving a writing command and a reading command synchronously; wherein the writing command is utilized to write data into the memory, and the reading command is utilized to read data from the memory; and the control interface comprising:
a selecting module capable of selecting a command from the two commands and causing the memory to execute the selected command when the control interface receives the reading command and the writing command; and causing the memory to continuously execute the other command after the selected command is executed completely.

8. The memory device of claim 7, wherein when the control interface receives the reading command, the control interface is capable of receiving a reading address synchronously, the reading command is utilized to read data from the reading address of the memory; and the control interface is capable of receiving a writing address synchronously when receiving the writing command, the writing command is utilized to write data into the writing address of the memory.

9. The memory device of claim 7, wherein the control interface is capable of further receiving a clock, the clock comprises a plurality of periods, and the control interface synchronously receives the reading command and the writing command in the same clock period.

10. The memory device of claim 9, wherein the selecting module executes the two commands in the same clock period.

11. The memory device of claim 9, wherein the selecting module comprises:
a clock generator for generating an inner clock according to the clock received by the control interface, the frequency of the inner clock is a plurality of periods of the frequency of the clock; and
two sequencing units electrically connected to the clock generator;
wherein when the control interface synchronously receives the reading and writing commands, different periods of the inner clock are capable of enabling different sequencing units; and when each sequencing unit is enabled, a corresponding command is transferred to the memory to cause the memory to execute the command.

12. The memory device of claim 7, wherein the selecting mode comprises an arbitrator for selecting one command of the two commands according to a predetermined priority.

13. The memory device of claim 7, wherein the control interface further comprises a latching module, and when the selecting module selects to execute the reading command, the latching module is capable of storing data read according to the reading command.

14. The memory device of claim 7, wherein the memory is a single-port memory.
